(19) United States
(12) Patent Application Publication
(10) Pub. No.: US 2011/0008561 A1
(43) Pub. Date: Jan. 13, 2011

(54) SHEET FOR PACKAGING ELECTRONIC PART

(75) Inventors: Hirokazu Kawauchi, Chiba (JP); Masatoshi Kawata, Gunma (JP); Takayuki Ando, Chiba (JP); Yasuhiro Arai, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Denki Kagaku Kogyo Kabushiki Kaisha, Tokyo (JP)

(21) Appl. No.: 12/810,719

(22) PCT Filed: Dec. 25, 2008
(86) PCT No.: PCT/JP08/73526

§ 371 Date: Sep. 14, 2010

(30) Foreign Application Priority Data
Dec. 26, 2007 (JP) 2007-333527

(51) Int. Cl. B65D 85/86; B65D 65/02; B29C 51/00; B29D 7/00

(52) U.S. Cl. 428/36.92; 428/220; 428/156; 264/160

(57) ABSTRACT

[Problems] Provided is a novel sheet for packaging electronic parts which is excellent in transparency and suitability for thickness reduction.

[Means for solving Problems] The sheet for packaging electronic parts is one obtained by biaxially drawing a styrene resin composition comprising 7 to 99.5 mass % of a polystyrene resin (A), 0.5 to 3 mass % of a high-impact polystyrene resin (B) which has a rubber content of 4 to 10 mass %, and 0 to 92.5 mass % styrene-conjugated diene block copolymer (C) wherein the molecular weight of the styrene block part is at least 10,000 and less than 130,000. This sheet has a thickness of 0.1 to 0.7 mm and an orientation release stress value as measured in conformity with ASTM D-1504 of 0.2 to 0.8 MPa.

### TECHNICAL FIELD

The present invention relates to a sheet for packaging electronic parts, a container for packaging electronic parts, particularly a carrier tape, produced from such a sheet, and a method for producing the carrier tape.

### BACKGROUND ART

Conventionally, embossed carrier tapes obtained by thermoforming a sheet composed of a thermoplastic resin such as a vinyl chloride resin, a styrene resin or a polycarbonate resin into an embossed form are used as the carrier tapes for mounting electronic parts on electronic devices. Such embossed carrier tapes require measures to prevent electrostatic damage; for example, when the tape is used for electronic parts requiring excellent anti-static properties such as IC's or LSI, a sheet consisting of a resin composition obtained by adding an electrically conductive filler such as carbon black to the above-mentioned thermoplastic resin, or a usually opaque sheet in which an electrically conductive coating is applied to the surface of the above-mentioned resin sheet is used.

On the other hand, for embossed carrier tapes housing electronic parts that are less susceptible to being destroyed by electrostatic damage such as, for example, capacitors, in view of the advantages of visualizing the contained electronic parts from the outside and reading words written on the parts, a transparent-type embossed carrier tape having as its base material a thermoplastic resin having relatively good transparency among the above-mentioned resins is used.

However, the demand for miniaturizing these electronic parts and accelerating the mounting speed has resulted in problems not only of the destruction of parts by electrostatic disturbances but also of mounting failures caused by parts adhering or transferring to the carrier tape due to static electricity, and even transparent-type embossed carrier tapes are required to have anti-static properties as a measure against static electricity. As a result, the field of application of transparent-type embossed carrier tapes has been expanded to cover use for electronic parts required to have excellent anti-static properties such as IC's and LSI, further improvements of which are desired.

As sheets for transparent-type embossed carrier tapes, for example, as styrene resin sheets, sheets composed of a mixture of a general-purpose polystyrene resin and a styrene-butadiene block copolymer (for example, Patent Documents 1 and 2) and sheets consisting of a rubber-modified styrene polymer comprising styrene monomer units and (meth)acrylate ester monomer units (for example, Patent Documents 3 and 4) are known. Generally, a carrier tape is required to have a balance of physical properties such as transparency, impact resistance, bending strength and formability in accordance with its mode of use, and up until now, various investigations have been carried out in order to improve these characteristics and to obtain a good balance of the physical properties. Moreover, in order to further improve the above-mentioned balance of the physical properties, laminated sheets using the above-mentioned resins have also been proposed (for example, Patent Document 5).

However, when attempting to obtain an embossed carrier tape with a sufficient anti-static property (by increasing the added amount of anti-static agent), there is a problem in that the necessary mechanical characteristics of the sheet such as transparency, impact resistance strength and bending strength tend to be insufficient. Further, when forming carrier tapes by thermoforming these sheets, it is not easy to obtain a sufficient buckling strength for pockets housing the electronic parts and thickness reduction is difficult. There is thus a need for a sheet for embossed carrier tapes that has a better balance of these required characteristics. Further, there is also a need to reduce as much as possible the shavings produced when slitting the sheet for a carrier tape or when opening holes for pitch feeding during the formation of the carrier tape.

Patent Document 1: JP-A 2002-332392

Patent Document 2: JP-A 2003-055526

Patent Document 3: JP-A H10-279755

Patent Document 4: JP-A 2003-253069

Patent Document 5: JP-A 2003-253069

### SUMMARY OF THE INVENTION

The present invention addresses the problem of providing a sheet for packaging electronic parts that at least partially solves various defects seen in conventional sheets, and has the object of obtaining a sheet that has a superior balance of physical properties such as transparency, bending strength and impact resistance in particular and can be suitably used in the production of a carrier tape.

Moreover, other problems addressed by the present invention are to provide a container for packaging electronic parts obtained by thermoforming the above sheet, for example, a carrier tape, and to obtain, in particular, an embossed carrier tape having sufficient pocket strength.

Further, the present invention also provides a method suitable for the production of the above carrier tape.

According to the present invention, a sheet for packaging electronic parts consisting of a biaxially oriented styrene resin sheet is provided. The sheet for packaging electronic parts has a controlled orientation release stress value; for example, the orientation release stress value measured in conformity with ASTM D-1504 is 0.2 to 0.8 MPa, for example, 0.3 to 0.6 MPa. Moreover, the thickness of the sheet can be within the range of 0.1 to 0/7 mm, for example, 0.1 to 0.45mm, and can further be 0.12 to 0.4 mm.

In one aspect of the present invention, the styrene resin used in the production of the above sheet is a resin composition composed of a mixture of several styrene resins, the resin composition consisting of a polystyrene resin (A) and a high-impact polystyrene resin (B) and further comprising a styrene-conjugated diene block copolymer (C) as an optional component. That is to say, the resin composition used in the production of the above sheet is a resin composition consisting of a polystyrene resin (A) and a high-impact polystyrene resin (B), or a resin composition further comprising a styrene-conjugated diene block copolymer (C) in addition to the polystyrene resin (A) and high-impact polystyrene resin (B).

In one aspect of the present invention, the above-mentioned polystyrene resin

(A) is a general-purpose polystyrene resin and is mixed at, for example, 7 to 99.5 mass % with respect to the total mass of the resin composition. The above-mentioned high-impact styrene resin (B) is preferably of a type comprising a rubber content of 4 to 10 mass %, and is mixed at, for example, 0.5 to 3 mass % with respect to the total mass of the resin composition. The above-mentioned styrene-conjugated diene block copolymer (C) is preferably one with the molecular weight of the styrene block part being at least 10,000 and less than 130,000, and mixed at, for example 0 to 92.5 mass % with respect to the total mass of the resin composition.

As such, in one aspect, the styrene resin from which the above sheet is produced is a resin composition comprising 7 to 79.5 mass % of the above-mentioned polystyrene resin (A), 0.5 to 3 mass % of the above-mentioned high-impact polystyrene resin (B) and 20 to 90 mass % of the above-mentioned styrene-butadiene block copolymer (A). The styrene-conjugated diene block copolymer (C) is, for example, a copolymer comprising 70 to 90 mass % of styrene and 10 to 30 mass % of a conjugated diene. Moreover, in another aspect, the styrene resin from which the above sheet is produced is a resin composition comprising 97 to 99.5 mass % of the above-mentioned polystyrene resin (A) and 0.5 to 3 mass % of the above-mentioned high-impact polystyrene resin (B).

Moreover, according to the present invention, a container for packaging electronic parts formed by thermoforming the above sheet for packaging electronic parts, particularly a carrier tape, is provided. The carrier tape is obtained by, for example, slitting the sheet for packaging electronic parts into the form of a tape and heating only a central portion in the width direction of the tape to form cavities by thermoforming.

Further, according to the present invention, a method for producing the above carrier tape is provided, and in one aspect, the method comprises the steps of, for example, slitting the sheet for packaging electronic parts into the form of a tape and heating only a central portion in the width direction of the tape to form cavities by thermoforming.

### MODES FOR CARRYING OUT THE INVENTION

The sheet for packaging electronic parts according to one embodiment of the present invention is a biaxially oriented styrene resin sheet. Here, “styrene resin” means a homopolymer or a copolymer of a styrene monomer and refers to various resins in which styrene units are the main components, such as general-purpose polystyrene resins (hereafter referred to as “GPPS resin”), high-impact polystyrene resins (hereafter referred to as “HIPS resin”), styrene-conjugated diene block copolymers and styrene-(meth)acrylate ester copolymer etc. and mixtures of at least one of these resins.

In one embodiment, GPPS and HIPS are particularly used even among styrene resins as the raw material of the above-mentioned styrene resin for producing the above-mentioned sheet, and depending on the situation, a resin comprising a styrene-conjugated diene block copolymer is combined as the optional component resin. A formulation example of the resin composition would be 7 to 99.5 mass % of a GPPS resin, 0.5 to 3 mass % of a HIPS resin (B) and 0 to 92.5 mass % of a styrene-conjugated diene block copolymer.

As such, in a representative embodiment, the sheet for packaging electronic parts is produced from a raw material, which is a resin composition comprising 7 to 99.5 mass % of a GPPS resin (A), 0.5 to 3 mass % of a HIPS resin (B), and 0 to 92.5 mass % of a resin comprising a styrene-conjugated diene block copolymer (C).

In the above, the GPPS resin (A) is a resin constituted by basically styrene units, and in order to maintain the strength and transparency of the sheet for packaging electronic parts, the weight average molecular weight may be, but is not particularly limited to, for example, 200,000 to 400,000, preferably 220,000 to 350,000 and particularly preferably 220,000 to 260,000 based on polystyrene conversion through gel permeation chromatography (GPC).

Moreover, the HIPS (B), as previously described, is a resin commonly called a “high-impact polystyrene resin”, and may include those in which styrene is graft polymerized in the presence of a rubber component such as a diene rubber. From the perspectives of transparency and strength, the rubber content is preferably 4 to 10 mass % when making HIPS 100 mass %; those having a rubber particle diameter of 0.5 to 4 μm are preferred, and those further having a superior resin fluidity of 5 g/10 min and above are preferred. Further preferred is 5 to 10 g/10 min.

In addition, the rubber particle diameter refers to a mean particle diameter based on volume and the fluidity is a value measured in accordance to JIS K7210.

The styrene-conjugated diene block copolymer (C) is an optional resin component as previously described, and is in its structure, a polymer comprising a polymer block with a styrene monomer as the main constituent and a polymer block with a conjugated diene monomer as the main constituent. The styrene monomer may include styrene, o-methyl styrene, p-methyl styrene, p-tert-butyl styrene, 1,3-dimethyl styrene, α-methyl styrene, vinyl naphthalene, vinyl anthracene and 1,1-diphenylethylene etc., among which styrene is preferred. One or more types of styrene monomers can be used. A conjugated diene monomer is a compound having a conjugated double bond in its structure and may include, for example, 1,3-butadiene (butadiene), 2-methyl-1,3-butadiene (isoprene), 2,3-dimethyl-1,3-butadiene, 1,3-pentadiene, 1,3-hexadiene and 2-methylpentadiene, among which butadiene and isoprene are preferred. One or more types of conjugated diene monomers can be used.

One or more types of the styrene-conjugated diene block copolymers can be used, and commercially available ones can be used as is. Particularly preferred is a styrene-butadiene block copolymer.

Moreover, for the block structure of the styrene-conjugated diene block copolymer, as long as the transparency and processability of the sheet for packaging electronic parts are not compromised, styrene-conjugated diene block copolymers of various block structures can be adopted; however, in order to achieve good transparency, strength and suppression of shaving production during the sheet slitting step, punching step and perforating step etc. of the sheet for packaging electronic parts, a copolymer with a styrene content of 70 to 90 mass %, a butadiene content of 10 to 30 mass % and the molecular weight of the styrene block part being 10,000 to 130,000 is provided as an example. Here, if the molecular weight of the styrene block part is less than 10,000, the transparency of the sheet for packaging electronic parts decreases, thereby compromising the appearance of the formed piece. Moreover, when the molecular weight of the styrene block part is 130,000 or above, the compatibility with the polystyrene resin is good and the transparency of the sheet for packaging electronic parts is high; however, the fluidity during the extrusion forming step is markedly reduced, making it necessary to increase the extrusion temperature to a high temperature, thereby lowering the formability. Further, extrusion processing at a high temperature becomes necessary and the drawing temperature is increased, resulting in reduced strength.

Additionally, the molecular weight of the styrene block part in the present invention is obtained from a standard curve produced by using standard polystyrenes and styrene oligomers, using the molecular weight corresponding to each peak in GPC determination (using an ultraviolet spectrophotometric detector set at wavelength 254 nm as the detector) of vinyl aromatic hydrocarbon polymer components obtained from the ozonolysis of the block copolymer [the method described in Y. Tanaka, et al. Rubber Chemistry and Technology, 59, 16 (1986)]. Here, for a block copolymer comprising multiple styrene block parts of different molecular weights, the molecular weights of the multiple styrene block parts are obtained for each block. In this situation, it is acceptable as long as one of the styrene block parts has a molecular weight of 10,0000 to 130,000; however, it is preferred that all the styrene block parts have a molecular weight of 10,000 to 130,000.

As such, for the raw material resin of the biaxially oriented styrene resin sheet according to one embodiment of the present invention, even among styrene resins, a styrene resin composition comprising 7 to 99.5 mass % of a GPPS (A), 0.5 to 3 mass % of a HIPS (B) which has a rubber content of 4 to 10 mass % and 0 to 92.5 mass % of a styrene-conjugated diene block copolymer (C) in which the molecular weight of the styrene block part is 10,000 to 130,000 is used.

In the above, when the content of GPPS (A) is less than 7 mass %, the tensile modulus of the sheet is low and the buckling strength of the pockets when forming a carrier tape is insufficient. On the other hand, as shall be described later, the inclusion of HIPS (B) at 0.5 mass % is important for a biaxially oriented styrene resin sheet, and therefore, the maximum content of GPPS (A) is 99.5 mass %.

The content of HIPS (B) in the raw material resin, when considering the lubricity of the surface of the sheet, is preferably at least 0.5 mass % or higher, and when considering the transparency and strength, is maximally 3 mass %. In order to achieve high transparency, 0.5 to 2 mass % is preferred.

On the other hand, the styrene-conjugated diene block copolymer (C) is an optional resin component, and does not need to be included; however, when GPPS (A) and HIPS (B) are reduced, a maximum of 92.5 mass % may be included. Moreover, with a view to satisfying all the previously described problems of the present invention, a styrene resin having the styrene-conjugated diene block copolymer at 20 to 90 mass % is preferred, 40 to 90 mass % is further preferred, and correspondingly, the content of GPPS (A) is preferably 7 to 79.5 mass %, and more preferably 7 to 59.5 mass %. By setting such ranges, it is possible to suppress generation of shavings during perforation processing or slitting of the sheet into the form of a tape when forming the sheet into a carrier tape

Various additives, for example, stabilizers (phosphorus-based, sulfur-based and hindered phenolic antioxidants etc., ultraviolet absorbing agents and thermal stabilizers etc.), plasticizing agents (mineral oil etc.), anti-static agents, lubricants (stearic acid, fatty acid esters etc.) and mold releasing agents etc. within the range not compromising the object of the present invention may be added to the above-mentioned resin composition. Further, inorganic particles (calcium phosphate, barium sulfate, talc, zeolite, silica etc.) may also be used.

The above-mentioned sheet for packaging electronic parts can be produced from the above-mentioned resin composition by common methods. For example, in one embodiment, it can be formed by melt-kneading (for example, kneading at a temperature of 170 to 240° C.) and extruding the above-described raw material resin composition from a die (especially a T-die) using an extruder, then, for example, sequentially or simultaneously biaxially drawing it along two axial directions, each at a draw ratio of 1.5 to 5 times, preferably 1.5 to 4 times, and more preferably 2 to 3 times, at a temperature of 85 to 135° C. When the draw ratio is less than 1.5 times, the strength, especially the toughness, of the sheet for packaging electronic parts is lowered, and when the ratio exceeds 5 times, uneven thickness of the container formed by the thermoforming step such as vacuum forming/compressed air forming occurs easily. For that reason, it is preferable to keep the draw ratio at 5 times or less, making the sheet for packaging electronic parts almost homogeneously drawn across the entire sheet for packaging electronic parts. The sequential biaxial drawing method may include, for example, a method of drawing an original sheet, which is extrusion-formed using a T-die or calender, at a ratio of 1.5 to 4 times in one axial direction in a heated state of 90 to 135° C., then drawing it at a ratio of 1.5 to 4 times in a direction orthogonal to the above drawing direction while heated to 90 to 135° C.

The orientation release stress of the sheet for a carrier tape obtained as described above changes depending on conditions such as the constitution of the styrene resin composition, the above-mentioned drawing temperature and draw ratio used; however, by adjusting these conditions, it is possible to make a sheet having a fixed orientation release stress (contraction stress). That is to say, with such conditions adjusted, the orientation release stress (contraction stress at 130° C.) of the sheet for a carrier tape according to one embodiment of the present invention as measured in conformity with ASTM D-1504 would be 0.2 to 0.8 MPa, preferably 0.3 to 0.6 MPa. When the orientation release stress is less than 0.2, a sufficient transparency cannot be obtained, and when it exceeds 0.8, the formation of a carrier tape becomes difficult.

Moreover, in consideration of the transparency, strength, formability, prevention of shavings and suppression of burrs in the sheet, the thickness of the sheet for a carrier tape obtained as described above should be within the range of 0.1 to 0.7 mm, preferably 0.1 to 0.45 mm and more preferably 0.12 to 0.4 mm.

The sheet for packaging electronic parts of the present invention is produced from a biaxially oriented styrene resin, and therefore, as can be verified from the examples provided below, has a high transparency. As such, it is possible to reduce the differences in transparency caused by the differences in the thickness of formed and unformed parts of a container for packaging, and the visibility of the content can be heightened.

Moreover, since the sheet for packaging electronic parts of the present invention has a fixed sheet thickness and orientation release stress, thickness reduction is possible and shavings (resin dust) produced during post processing such as the sheet slitting step, punch processing and perforation processing of the formed piece can be greatly suppressed.

The sheet for a carrier tape may consist of a single layer or multiple layers. For example, to obtain a sheet for a carrier tape having multiple layers, the resin composition used for each constituting layer may be formed by multiple extruders and produced by a heat lamination method or the like to heat laminate and integrate the obtained sheets, and the resin composition for each constituting layer may be produced by a common co-extrusion method or the like employing a feed block attached die, multi-manifold die or the like. A thin surface layer can be obtained by the co-extrusion method, and is preferred because of superior mass productivity. By biaxially drawing such a laminated sheet using the above-mentioned method, a biaxially oriented laminated sheet of the present invention can be obtained.

When housing electronic parts easily destroyed by static electricity such as IC's, the surface of the carrier tape should be subjected to an anti-static treatment. The anti-static treatment can be achieved by, for example, applying an anti-static agent to the surface of the sheet for a carrier tape.

The sheet for a carrier tape can be subjected to a step of applying and drying a surface treating agent such as a mold releasing agent or anti-static agent, then rolled into a roll. Before applying the surface treating agent, in order to increase the applicability of the surface treating agent, a corona treatment or the like should preferably be performed.

Moreover, it is also possible to add an anti-static agent to the resin composition as previously described to carry out the anti-static treatment.

The carrier tape of the present invention can be produced by slitting the above-mentioned sheet for a carrier tape into the form of a narrow tape and forming consecutive pockets for storing small electronic parts by thermoforming such as vacuum forming, compressed air forming, press forming or hot plate forming in the longitudinal direction of the tape.

Since in general, a biaxially oriented styrene resin sheet tends to thermally contract during thermoforming as mentioned above, hot plate forming, which is rarely influenced by such effects, has often been employed for uses such as food packaging etc. and has not been employed for molding in which a high degree of precision is required, such as the formation of a carrier tape. However, by making a resin composition such as the one previously described into a biaxially oriented sheet produced as previously described, slitting the sheet into the form of a tape, and heating the temperature of the sheet to 120 to 160° C. to perform thermoforming, it is possible to obtain a carrier tape that solves the problem s addressed by the present invention. Additionally, the thermoforming method is preferably press forming. Moreover, no matter which forming method is used, in order to further inhibit contraction in the width direction during heating of the tape, only the central portion of the tape should be heated and the two edges should be covered when pre-heating the tape.

The electronic parts housed in the carrier tape of the present invention may include, but are not particularly limited to, for example, ICs, LEDs (light emitting diodes), resistors, liquid crystal, capacitors, transistors, piezoelectric resistors, filters, crystal oscillators, crystal vibrators, diodes, connecters, switches, volumes, relays and inductors etc. The format of the ICs is not particularly limited. Examples include SOP, HEMT, SQFP, BGA, CSP, SOJ, QFP and PLCC.

### EXAMPLES

Herebelow, examples and comparative examples shall be provided; however, the present invention is not limited to these examples. Various performances of the sheet for a carrier tape were evaluated using the methods below.

### 1. Orientation Release Stress

In conformity with ASTM D-1504, MD and TD orientation release stresses of the sheet were measured. Additionally, MD is the direction in which the sheet was rolled and TD is the width direction of the tape.

### 2. Haze

Haze of the sheet was measured using Haze Meter NDH2000 manufactured by Nippon Denshoku Industries Co., Ltd. in conformity with JIS K 7105.

### 3. Tensile Modulus

Tensile modulus of the sheet was measured using a tensile tester in conformity with JIS K 7127.

### 4. Sheet Impact

The impact strength of the sheet was measured using Film Impact Tester manufactured by Tester Sangyo Co., Ltd. employing an impact tip of nose shape (R10).

### 5. Bending Strength

The number of times of repetitive bending taken to break a test piece of the sheet was measured using a bending strength tester in conformity with JIS P8115.

### 6. Evaluation on Formability

The sheet for a carrier tape in each example and comparative example was slit to be 24 mm wide, formed into an embossed carrier tape for packaging an IC of QFP 14 mm x 20 mm-64 pin by a compressed air forming machine manufactured by EDG, and the formability of the sheet was visually observed. The evaluation of the formability was performed using a 3-stage evaluation system in which ◯ was given to those with good formability, Δ was given to those with mediocre formability but still capable of emboss formation, and × was given to those that could not be emboss formed due to holes etc.

7. Shaving Production State during Perforation Processing

Sprocket holes of the embossed carrier tape formed as mentioned above by the compressed air forming machine manufactured by EDG were observed using a measuring microscope (manufactured by Mitutoyo Corporation). Taking the state with no shavings as 0%, the proportion of area covered by shavings in the sprocket holes was calculated.

### 8. Buckling Strength of the Formed Piece

The pockets of the embossed carrier tape obtained by the above-mentioned forming process were compressed from the bottom using a tensile tester and the buckling strength was measured.

In the examples and comparative examples, the following resins 1 to 6 were used as the raw material for the styrene resin. Here, Resin 1 is a GPPS resin (A), Resin 2 is a HIPS resin (B), Resins 3 to 5 are resins comprising a styrene-conjugated diene block copolymer (C) and Resin 6 is a resin comprising a rubber-modified styrene polymer comprising a (meth)acrylate ester monomer unit.
Resin 1: a GPPS resin with a weight average molecular weight of 240,000 (Toyo Styrol GP HRM61 manufactured by Toyo Styrene Co., Ltd.)
Resin 2: a HIPS resin with a styrene/rubber mass ratio of 95/5, a rubber particle diameter of 2.9 um and a fluidity of 7.0 g/10 min (Toyo Styrol HI H370 manufactured by Toyo Styrene Co., Ltd.)
Resin 3: a resin comprising a styrene-butadiene block copolymer with a styrene/butadiene mass ratio of 85/15 and styrene block parts with molecular weights of 24,000 and 125,000 (Clearen 850L manufactured by Denki Kagaku Kogyo Kabushiki Kaisha)
Resin 4: a resin comprising a styrene-butadiene block copolymer with a styrene/butadiene mass ratio of 75/25 and styrene block parts with molecular weights of 48,000 and 76,000 (Clearen 730L manufactured by Denki Kagaku Kogyo Kabushiki Kaisha)
Resin 5: a resin comprising a styrene-butadiene block copolymer with a styrene/butadiene mass ratio of 76/24 and styrene block parts with molecular weights of 15,000 and 71,000 (Clearen 210M manufactured by Denki Kagaku Kogyo Kabushiki Kaisha)
Resin 6: a resin comprising a rubber-modified styrene polymer comprising a styrene monomer unit with a styrene/butadiene/methyl methacrylate/n-butyl acrylate mass ratio of 50.5/6.0/36.5/7.0 and a (meth)acrylate ester monomer unit.

### Examples 1 to 11 and Comparative Examples 1 and 2

Resin 1 and Resin 2 were respectively used as the GPPS resin (A) and HIPS resin (B), the resin comprising a styrene-butadiene block copolymer (C) was selected from Resins 2 to 4 that differ in the styrene/butadiene mass ratio and molecular weight of the styrene block part, and Resin 6 was used as the resin comprising a (meth)acrylate ester monomer, which were mixed according to the compounding ratios shown in Tables 1 to 3 to prepare various resin compositions. Then, each resin composition was melt-kneaded and extruded from T-dice by an extruder to obtain an undrawn sheet. Next, the sheets were longitudinally drawn 2.3-fold by a longitudinal drawing machine, then transversely drawn 2.3-fold using a transverse drawing machine to obtain biaxially oriented sheets for packaging electronic parts according to Examples 1 to 11 and Comparative Examples 1 and 2. Then the orientation release stress, haze, tensile modulus, sheet impact and bending strength of the obtained sheets were measured according to the above measurement methods.

Moreover, as previously described, the obtained biaxially oriented sheets were slit to be 24 mm wide, formed into embossed carrier tapes for packaging an IC of QFP 14 mm x 20 mm-64 pin by a compressed air forming machine manufactured by EDG (Examples 1 to 10 and Comparative Example 2) and a press forming machine manufactured by Ohtori Kiko Co., Ltd. (Example 11 and Comparative Example 1), their formability and buckling strength were evaluated according to the previously described evaluation methods and shaving production inside their sprocket holes was examined. The results are shown together in Tables 1 to 3.

### Example 12

The same steps as those for Example 1 were repeated to prepare an undrawn sheet with the same sheet thickness consisting of a resin composition having the same resin composition and resin compounding ratio as Example 1. Next, the sheet was longitudinally drawn 1.5-fold by a longitudinal drawing machine, then transversely drawn 1.5-fold using a transverse drawing machine to obtain a biaxially oriented sheet for packaging electronic parts according to Example 12. Then, various physical properties of the obtained sheet were measured using the previously described evaluation methods. Moreover, an embossed carrier tape was formed by the same method as the above Examples and its formability etc. were examined. The results are shown together in Table 2.

### Example 13

In the same manner as in Example 1, an undrawn sheet with the same sheet thickness consisting of a resin composition having the same resin composition and resin compounding ratio as Example 1 was prepared. Next, the sheet was longitudinally drawn 4.5-fold by a longitudinal drawing machine, then transversely drawn 4.5-fold using a transverse drawing machine to obtain a biaxially oriented sheet for packaging electronic parts according to Example 13. Then, various physical properties of the obtained sheet were measured using the previously described evaluation methods. Moreover, an embossed carrier tape was formed by the same method as the above Examples and its formability etc. were examined. The results are shown together in Table 2.

### Comparative Example 3

In the same manner as in Example 1, an undrawn sheet with the same sheet thickness consisting of a resin composition having the same resin composition and resin compounding ratio as Example 1 was prepared. Next, the sheet was longitudinally drawn 5.8-fold by a longitudinal drawing machine, then transversely drawn 5.8-fold using a transverse drawing machine to obtain a biaxially oriented sheet for packaging electronic parts according to Comparative Example 3. Then, various physical properties of the obtained sheet were measured using the previously described evaluation methods. Moreover, an embossed carrier tape was formed by the same method as the above Examples and its formability etc. were examined. The results are shown together in Table 3.

### Comparative Examples 4 to 6

In the same manner as in Examples 1, 5 and 9, undrawn sheets having the same resin composition, resin compounding ratio and sheet thickness as these Examples were prepared and respectively used as the sheets for packaging electronic parts according to Comparative Examples 4, 5 and 6. Then, various physical properties of the obtained sheets were measured using the previously described evaluation methods. Moreover, embossed carrier tapes were formed by the same method as the above Examples and their formability etc. were examined. The results are shown together in Table 3.

### Comparative Example 7

Resin 6 comprising a rubber-modified styrene polymer containing a (meth)acrylate ester monomer unit was melt-kneaded by an extruder, extruded from T-dice to obtain an undrawn sheet, and the sheet was used as the sheet for packaging electronic parts according to Comparative Example 7. Then, various physical properties of the obtained sheet were measured using the previously described evaluation methods. Moreover, an embossed carrier tape was formed by the same method as the above Examples and its formability etc. were examined. The results are shown together in Table 3.

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| Resin | (A) | Resin 1 | 58.5 | 38.5 | 19.0 | 49.0 | 78.5 | 58.5 | 38.5 |
| Composition | (B) | Resin 2 | 1.5 | 1.5 | 1.0 | 1.0 | 1.5 | 1.5 | 1.5 |
| (mass %) | (C) | Resin 3 | 40.0 | 60.0 | 80.0 | — | — | — | — |
| | | Resin 4 | — | — | — | 50.0 | — | — | — |
| | | Resin 5 | — | — | — | — | 20.0 | 40.0 | 60.0 |

| | | | | | | | | |
|---|---|---|---|---|---|---|---|---|
| Sheet Thickness | (mm) | 0.25 | 0.25 | 0.25 | 0.25 | 0.25 | 0.25 | 0.25 |
| Orientation Release | (MPa) | 0.5/0.4 | 0.4/0.4 | 0.5/0.4 | 0.3/0.4 | 0.3/0.34 | 0.4/0.5 | 0.25/0.2 |
| Stress MD/TD | | | | | | | | |
| Haze | (%) | 1.7 | 2.4 | 2.2 | 4.6 | 3.5 | 4.1 | 4.7 |
| Tensile Modulus | (GPa) | 2.7/2.7 | 2.4/2.3 | 2.1/1.9 | 2.2/2.3 | 2.8/2.9 | 2.4/2.4 | 2.1/2.1 |
| MD/TD | | | | | | | | |
| Sheet Impact | (J/m) | 6960 | 7210 | 11010 | 7650 | 4540 | 5850 | 7380 |
| Strength | | | | | | | | |
| Bending Strength | (times) | 83/133 | 90/225 | 283/457 | 360/287 | 55/75 | 63/98 | 341/493 |
| MD/TD | | | | | | | | |
| Shaving Production | (%) | 3.5 | 3.7 | 3.8 | 4.5 | 4.2 | 3.8 | 3.7 |
| State | | | | | | | | |
| Formability | | ◯ | ◯ | ◯ | ◯ | ◯ | ◯ | ◯ |
| Buckling Strength of | (N) | 29.2 | 25.2 | 19.6 | 18.6 | 25.2 | 19.7 | 18.2 |
| the Formed Pockets | | | | | | | | |

(Note)
The unit for Resin 1 to Resin 5 is mass %.

TABLE 2

| | | | Ex. 8 | Ex. 9 | Ex. 10 | Ex. 11 | Ex. 12 | Ex. 13 |
|---|---|---|---|---|---|---|---|---|
| Resin | (A) | Resin 1 | 57.0 | 98.5 | 58.5 | 58.5 | 58.5 | 58.5 |
| Composition | (B) | Resin 2 | 3.0 | 1.5 | 1.5 | 1.5 | 1.5 | 1.5 |
| (mass %) | (C) | Resin 3 | 40.0 | — | 40 | 40 | 40 | 40 |
| | | Resin 4 | — | — | — | — | — | — |
| | | Resin 5 | — | — | — | — | — | — |

| | | | | | | | |
|---|---|---|---|---|---|---|---|
| Sheet Thickness | (mm) | 0.25 | 0.25 | 0.15 | 0.4 | 0.25 | 0.25 |
| Orientation Release | (MPa) | 0.6/0.5 | 0.5/0.4 | 0.3/0.3 | 0.5/0.5 | 0.3/0.2 | 0.7/0.6 |
| Stress MD/TD | | | | | | | |
| Haze | (%) | 2.8 | 2.2 | 1.7 | 1.9 | 1.7 | 1.8 |
| Tensile Modulus | (GPa) | 2.9/2.8 | 3.2/3.1 | 2.5/2.4 | 2.7/2.8 | 2.7/2.6 | 2.7/2.8 |
| MD/TD | | | | | | | |
| Sheet Impact Strength | (J/m) | 7820 | 4845 | 4620 | 7050 | 5230 | 7230 |
| Bending Strength | (times) | 176/212 | 30/7 | 152/221 | 82/119 | 64/115 | 92/129 |
| MD/TD | | | | | | | |
| Shaving Production | (%) | 3.6 | 8.5 | 3.2 | 4.6 | 3.6 | 4.2 |
| State | | | | | | | |
| Formability | | ◯ | ◯ | ◯ | ◯ | ◯ | ◯ |
| Buckling Strength of | (N) | 28.4 | 25.5 | 20.2 | 30.2 | 12.5 | 15.2 |
| the Formed Pockets | | | | | | | |

(Note)
The unit for Resin 1 to Resin 5 is mass %.

TABLE 3

| | | Co. Ex. 1 | Co. Ex. 2 | Co. Ex. 3 | Co. Ex. 4 | Co. Ex. 5 | Co. Ex. 6 | Co. Ex. 7 |
|---|---|---|---|---|---|---|---|---|
| (A) | Resin 1 | 58.5 | 4.5 | 58.5 | 58.5 | 78.5 | 98.5 | — |
| (B) | Resin 2 | 1.5 | 1.5 | 1.5 | 1.5 | 1.5 | 1.5 | — |
| (C) | Resin 3 | 40.0 | 94.0 | 40.0 | 40.0 | — | — | — |
| | Resin 4 | — | — | — | — | — | — | — |
| | Resin 5 | — | — | — | — | 20.0 | — | — |
| | Resin 6 | — | — | — | — | — | — | 100 |

| | | | | | | | | |
|---|---|---|---|---|---|---|---|---|
| Sheet Thickness | (mm) | 0.8 | 0.25 | 0.25 | 0.25 | 0.25 | 0.25 | 0.25 |
| Orientation | (MPa) | 0.2/0.2 | 0.3/0.4 | 0.9/0.9 | 0.1/0.1 | 0.1/0.08 | 0.1/0.1 | 0.1/0.1 |
| Release Stress | | | | | | | | |
| MD/TD | | | | | | | | |
| Haze | (%) | 1.8 | 2.4 | 2.0 | 1.8 | 3.7 | 2.3 | 8.3 |
| Tensile Modulus | (GPa) | 2.6/2.5 | 2.0/1.8 | 2.8/2.8 | 2.6/2.5 | 2.7/2.7 | 2.8/2.7 | 1.6/1.6 |
| MD/TD | | | | | | | | |
| Sheet Impact | (J/m) | 420 | 12080 | 7420 | 4520 | 2050 | 1240 | 13240 |
| Strength | | | | | | | | |
| Bending | (times) | 23/42 | 304/486 | 18/24 | 23/42 | 15/21 | 5/5 | 19/13 |
| Strength MD/TD | | | | | | | | |
| Shaving | (%) | 3.8 | 3.2 | 4.2 | 4.8 | 6.0 | 8.2 | 6.3 |
| Production State | | | | | | | | |
| Formability | | X | Δ | X | ◯ | Δ | X | Δ |
| Buckling | (N) | Not | 9.2 | Not | 6.4 | 6.2 | Not | 5.2 |
| Strength of the | | evaluable | | evaluable | | | evaluable | |
| Formed Pockets | | | | | | | | |

(Note)
The unit for Resin 1 to Resin 6 is mass %.

As can be seen from the results of the above tables, the sheets for packaging electronic parts according to Examples 1 to 13, which were produced from a resin composition comprising a GPPS resin (A), a HIPS resin (B), and depending on the situation, a styrene-butadiene block copolymer (C) at predetermined amounts, with the sheet thickness and orientation release stress controlled within a desired range, have superior haze (transparency), tensile modulus, sheet impact strength and bending strength. Moreover, the embossed carrier tapes according to Examples 1 to 13 have superior formability and buckling strength of the formed pockets, and the shaving production state during perforation processing is also suppressed.

1. A sheet for packaging electronic parts, formed by biaxially drawing a styrene resin composition comprising 7 to 99.5 mass % of a polystyrene resin (A), 0.5 to 3 mass % of a high-impact polystyrene resin (B) which has a rubber content of 4 to 10 mass %, and 0 to 92.5 mass % of a styrene-conjugated diene block copolymer (C) wherein the molecular weight of the styrene block part is from 10,000 to 130,000; the thickness of the sheet being 0.1 to 0.7 mm and the orientation release stress value as measured in conformity with ASTM D-1504 is from 0.2 to 0.8 MPa.

2. The sheet for packaging electronic parts according to claim 1, wherein said styrene resin composition comprises 7 to 79.5 mass % of said polystyrene resin (A), 0.5 to 3 mass % of said high-impact polystyrene resin (B) and 20 to 90 mass % of said styrene-conjugated diene block copolymer (C).

3. The sheet for packaging electronic parts according to claim 1, wherein said styrene resin composition comprises 97 to 99.5 mass % of said polystyrene resin (A) and 0.5 to 3 mass % of said high-impact polystyrene resin (B).

4. The sheet for packaging electronic parts according to claim 1, wherein said styrene-conjugated diene block copolymer (C) is a copolymer comprising 70 to 90 mass % of styrene and 10 to 30 mass % of a conjugated diene.

5. A container for packaging electronic parts, thermoformed from the sheet for packaging electronic parts according to claim 1.

6. A carrier tape, thermoformed from the sheet for packaging electronic parts according to claim 1.

7. The carrier tape according to claim 6, wherein said sheet for packaging electronic parts is slit into the form of a tape and only a central portion in the width direction of the tape is heated to form cavities by thermoforming.

8. A method for producing a carrier tape, comprising slitting the sheet for packaging electronic parts according to claim 1 into the form of a tape, and heating only a central portion in widthwise direction of the tape to form cavities by thermoforming.

9. A container for packaging electronic parts, thermoformed from the sheet for packaging electronic parts according to claim 2.

10. A carrier tape, thermoformed from the sheet for packaging electronic parts according to claim 2.

11. The carrier tape according to claim 12, wherein said sheet for packaging electronic parts is slit into the form of a tape and only a central portion in the width direction of the tape is heated to form cavities by thermoforming.

12. A method for producing a carrier tape, comprising slitting the sheet for packaging electronic parts according to claim 2 into the form of a tape, and heating only a central portion in widthwise direction of the tape to form cavities by thermoforming.
